(19) United States
(12) Patent Application Publication
(10) Pub. No.: US 2026/0226337 A1
(43) Pub. Date: Aug. 6, 2026

(54) SETTABLE SCAVENGER SPACER FLUID FOR DISPLACING DRILLING MUD

(71) Applicant: Schlumberger Technology Corporation, Sugar Land, TX (US)

(72) Inventors: Roderick Pernites, Sugar Land, TX (US); Xia Wei, Sugar Land, TX (US)

(21) Appl. No.: 19/451,342

(22) Filed: Jan. 16, 2026

Related U.S. Application Data
(60) Provisional application No. 63/745,960, filed on Jan. 16, 2025.

(51) Int. Cl. C09K 8/40; C09K 8/42; C09K 8/44; E21B 21/00; E21B 33/138

(52) U.S. Cl. CPC C09K 8/40; C09K 8/424; C09K 8/44; E21B 21/003; E21B 33/138

(57) ABSTRACT

Described herein are settable spacer fluids and methods of making and using such fluids. The settable spacer fluids generally contain a polymerizable raw material and activator in aqueous medium, where the spacer fluid is configured to have density sufficient to displace fluids within a well and to solidify after a duration sufficient to allow use of the spacer fluid to aid in well development and placement of the spacer fluid at a target location prior to significant transformation. The spacer fluid solidifies over time, but can be used with final compressive strength as low as 50 psi.

### CROSS-REFERENCE TO RELATED APPLICATIONS

This application claims the benefit of, and priority to, U.S. patent application Ser. No. 63/745,960, filed Jan. 16, 2024, which application is incorporated herein by this reference in its entirety.

### FIELD

This patent application describes methods for drilling wells. In particular, this application describes methods of making and using pumpable spacer fluids for well completion that can transform into solid materials.

### BACKGROUND

Spacer fluids are used in well drilling and completion operations to displace drilling fluids from the well in preparation for other operations. Drilling fluids are used to facilitate extension of the well into the earth by lubricating the drill bit, moderating temperature, and circulating drill cuttings away from the location of contact between the drill bit and the subterranean formation, among other benefits.

The well may be drilled for many different uses. Wells are drilled for recovering fluid materials, such as hydrocarbon and metal-bearing water, from the earth. The well may be used for carbon capture, utilization, and storage (CCUS) and/or for recovery and use of geothermal energy. Geothermal energy is a promising source of renewable energy that captures energy from heat generated or stored within the earth. For example, geothermal energy may be used to perform climate control (e.g., heating, cooling) for structures (e.g., buildings) using heat pumps and/or to generate electricity (e.g., by heating water to generate steam and drive a turbine with the steam). The wells described herein may be used to circulate a working fluid that exchanges heat within the earth formation through which the wellbore extends. The working fluid may be circulated to the surface where a surface heat exchanger is used to transfer thermal energy to another fluid used to generate electricity and/or for climate control. After the thermal energy is transferred from the working fluid in the surface heat exchanger, the working fluid is circulated back to the earth formation to continue the cycle.

CCUS facilitates the capture, use, and/or storage of carbon (e.g., carbon dioxide), which has a goal of achieving carbon neutrality and/or net zero carbon emissions (NZE). Carbon capture may include the capture of carbon dioxide from large point sources, such as power plants, refineries, cement plants, other industrial processing plants, or other industrial facilities that use fossil fuels, biomass fuels, or other fuels that generate carbon dioxide. The captured carbon dioxide may be converted into valuable products such as, for example, ethanol, sustainable aviation fuel, chemicals, mineral aggregates, and/or other products. Alternatively, the carbon dioxide may be stored in geologic formations, such as in depleted hydrocarbon reservoirs. The carbon dioxide may be introduced into the earth formation through a wellbore, such as the wellbores described herein. In the earth formation, the carbon in the carbon dioxide may be dispersed in an aqueous phase and stored as carbon dioxide, may be stored in mineral form (e.g., as a carbonate, such as calcium carbonate, magnesium carbonate, iron(II) carbonate), or as another form of carbon. Wells for these, and many other uses, can be drilled using drilling fluids as fluid aids.

At times during well construction, particularly when preparing for well completion, the drilling fluid is usually removed from the well by displacing the drilling fluid using another fluid. In many cases, the drilling fluid is displaced from the well so that a solid wall, called an annular seal, can be constructed along the earthen wall of the well to strongly adhere to the earthen wall, fortify the wall, give mechanical support to the casing, provide zonal isolation, and prevent unwanted fluids from flowing into the well from the subterranean formation. The solid wall is usually constructed by pumping a settable material, usually a cementitious precursor, down the well and into an annulus between the well wall and a metal casing inserted into the well. The cementitious precursor flows to the bottom of the well and then upward along the annulus. Flow of the cementitious precursor displaces the drilling fluid along the annulus to the surface.

An intermediate fluid called spacer is often pumped into the well between the drilling fluid and the cementitious precursor to avoid mixing between the drilling fluid and the cementitious precursor, especially when the drilling fluid is not an aqueous fluid. Conventionally, the spacer fluid is an aqueous mixture containing solids added to achieve a certain bulk density so the spacer fluid weighs enough to displace the drilling fluid from the well. The spacer fluid also typically contains materials to facilitate stable suspension of the solids in the aqueous liquid medium. In some cases, the spacer fluid is left in the well for economic reasons. Spacer fluids, however, typically cannot provide wellbore sealing and fortification needed for well completion. There is a need for spacer fluids that can be used to displace drilling fluids from a well and can subsequently solidify and develop some structural strength.

### SUMMARY

Embodiments described herein provide a method of treating a well, including pumping a spacer fluid into the well, the spacer fluid comprising an aqueous medium, a polymerizable raw material, and an activator system that comprises 1) an activator and a release delay structure; or 2) an activator with a retardant reagent; or 3) an activator solution that gives the spacer fluid a pH of about 12 or less; displacing the spacer fluid to a target location within the well; and allowing the spacer fluid to solidify at the target location.

Other embodiments described herein provide a method of treating a well, comprising pumping a drilling fluid into a well; displacing the drilling fluid using a polymerizable spacer fluid; displacing the polymerizable spacer fluid to a target location within the well; and allowing the spacer fluid to polymerize at the target location.

Other embodiments herein provide a spacer fluid for use in a well, the spacer fluid comprising an aqueous medium; and a slow polymerization mixture that solidifies the spacer fluid after a predetermined time disposed in the aqueous medium.

### DETAILED DESCRIPTION

In the following description, numerous details are set forth to provide an understanding of the present disclosure. However, it may be understood by those skilled in the art that the methods of the present disclosure may be practiced without these details and that numerous variations or modifications from the described embodiments may be possible.

At the outset, it should be noted that in the development of any such actual embodiment, numerous implementation—specific decisions are made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary of the disclosure and this detailed description, each numerical value should be read once as modified by the term “about” (unless already expressly so modified), and then read again as not so modified unless otherwise indicated in context. The term “about” should be understood as any amount or range within 10% of the recited amount or range (for example, a range from about 1 to about 10 encompasses a range from 0.9 to 11). Also, in the summary and this detailed description, it should be understood that a concentration range listed or described as being useful, suitable, or the like, is intended that any concentration within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, even if specific data points within the range, or even no data points within the range, are explicitly identified or refer to a few specific data points, it is to be understood that inventors appreciate and understand that any data points within the range are to be considered to have been specified, and that inventors possessed knowledge of the entire range and the points within the range.

Regarding chemical formulas, it should be noted that measurements may not conform precisely to the chemical formulas described herein due to various sources of error that can affect real-world testing. The chemical formulas described herein should therefore be understood as expressing the nominal chemical makeup of compounds, where real-world testing may show close, but not exact, conformity to the formulas.

As used herein, “embodiments” refers to non-limiting examples disclosed herein, whether claimed or not, which may be employed or present alone or in any combination or permutation with one or more other embodiments. Each embodiment disclosed herein should be regarded both as an added feature to be used with one or more other embodiments, as well as an alternative to be used separately or in lieu of one or more other embodiments. It should be understood that no limitation of the scope of the claimed subject matter is thereby intended, any alterations and further modifications in the illustrated embodiments, and any further applications of the principles of the application as illustrated therein as would normally occur to one skilled in the art to which the disclosure relates are contemplated herein.

Spacer fluids are described herein that can be used to displace drilling fluids when constructing subterranean wells, and can subsequently be solidified into a material that provides well sealing and support. The spacer fluids have high pH to facilitate removal of oleaginous components of the drilling fluid from the well along with materials that can solidify after the spacer fluid is placed at a desired location. The spacer fluids thus contain materials, such as polymerizable raw materials, that can transform the spacer fluid into a solid in a high pH environment. A type of polymerizable raw materials suitable for such use is an alkali-reactive aluminum-silicon-oxygen material, which can form a polysialate matrix in a high pH environment. A polysialate is a three-dimensional inorganic polymer having the general formula Mₐ-[(Si—O—Al—O)_{b}—(Si—O)_{c}]_{d}, where M is a metal, for example an alkali metal, alkaline earth metal, or transition metal, and many such metals can be present in one polysialate system. Examples of metals that can be present in a polysialate system include sodium, potassium, calcium, magnesium, iron, copper, and cobalt, but the metals that can be found in a polysialate system are not particularly limited. The values of the formulation constants a, b, c, and d generally affect properties of the polysialate system. The ratio of silicon to aluminum in the polymerizable raw materials generally determines the c/b ratio, and the degree of polymerization, d, is generally influenced by amounts of polymerizable raw material and activator in the system. The degree of polymerization affects strength of the final polymer. The type and quantity, a, of metals present can affect physical and chemical characteristics of the final polymer, such as density and reactivity with other substances.

In general, polysialate raw materials are materials containing aluminum, silicon, and oxygen that have been made alkali-reactive by prior thermal treatment. Many such materials are aluminosilicate materials having a defined matrix of aluminum, silicon, and oxygen, but some materials that can be used are not aluminosilicate materials. Examples of polysialate raw materials include ASTM Class C fly ash, ASTM Class F fly ash, fly ash not classified by ASTM, volcanic ash, volcanic glass, slag, ferrous slag, ferroalloy slag, non ferrous slag, such as copper slag, nickel slag, tin slag, zinc slag, and the like, blast furnace slag, basic oxygen furnace slag, electric arc furnace slag, and ground slags, such as ground blast furnace slag, ground granulated blast furnace slag (GGBS), diatomaceous earths, pumice, and calcined clays, which may be partially or fully calcined clays (metakaolin is a partially calcined clay), aluminum-containing silica fume, natural aluminosilicate, feldspars, which may be dehydrated, alumina and silica sols, synthetic aluminosilicate glass powder, zeolite, scoria, allophone, bentonite, pumice, and red mud, which may be calcined. Some aluminosilicates with alkali-activated reactivity are ashes produced by combustion of some forest or agricultural industry by-products commonly known as biomass ash, or more specifically biomass fly ash, from various sources such as witchgrass ash, walnut shell ash, rice husk ash, and the like. Many alkali reactive polysialate raw materials contain a significant proportion of an amorphous aluminosilicate phase, which reacts in strong alkaline solutions. In some cases, alumina and silica may be added separately to a mixture containing alkali-reactive aluminosilicate materials, for example as bauxite and silica fume. Thermally-activated bauxite and silica fume can also form a polysialate system in a high pH solution. Other amorphous silica sources can also be used, which may include soda-lime glass dust, borosilicate glass dust, microsilica, fumed silica, precipitated silica, nanosilica, rice husk ash, or a combination thereof. These alkali-reactive aluminum-silicon-oxygen materials become reactive when placed in strongly alkaline environments, typically at pH greater than 11 but many of these materials will react more slowly at lower pH, for example as low as 9. The materials described above react under such conditions to form sialate (silicon-aluminum-oxygen) polymers, making them suitable polysialate raw materials. Binder components such as Portland cement, kaolin, bauxite, aluminum oxide, and aluminum hydroxide can also be included.

Polysialate raw materials can be engineered substances. Materials that contain aluminum, silicon, and oxygen can be brought together in a mixture and subjected to conditions that result in atomic rearrangement of aluminum, silicon, and oxygen in the materials into a polymerizable material. Thus, materials like silica and alumina can be processed together in an energetic process, such as milling or grinding, to accomplish a chemomechanical treatment of the materials that creates an alkaline-reactive aluminum-silicon-oxygen material that may be, or may include, aluminosilicate. Such materials can be used as polysialate raw materials like, with, or instead of the materials described above. Thermal energy and/or plasma energy can be added to such energetic transformation processes to increase or encourage the atomic rearrangement. Oxygen components such as molecular oxygen, air, ozone, and the like, can be added to the atmosphere of such processes to enhance the formation of the alkaline-reactive polysialate raw material.

Such materials are added to an aqueous mixture along with an activator, which is a material that raises the pH of the aqueous mixture, thus activating a polysialation reaction. Alkaline activators can be used as solid materials or as liquid materials. Dry materials such as alkali metal silicates (e.g. metasilicates, orthosilicates, pyrosilicates), alkaline earth metal oxides and hydroxides, and alkali metal salts such as carbonates, sulphates, sulphites, phosphates, oxalates, fluorides, hexafluoridosilicates, iodates, and molybdates, and derivatives thereof such as hydrogenated salts, can be used. Alkaline solutions, such as sodium hydroxide or potassium hydroxide solution, can also be used, and combinations of any of the above materials can be used.

In general, activators that can be used in spacer materials may be alkali metal hydroxide, an alkaline-earth metal hydroxide, alkali metal salt or combinations thereof, in solid or aqueous solution. Alkali metal hydroxides may be hydroxides of sodium, potassium, cesium, rubidium, or combination thereof. Alkaline-earth metal hydroxides that can be used include calcium, magnesium, barium, and strontium hydroxide, or combination thereof. The metal hydroxide may be in the form of a solid or an aqueous mixture. Alkali metal salt may include selected from the group consisting of M₂CO₃, M₂SO₄, M₃PO₄, M₂C₂O₄, M₂ₓSi_{y}O_{2y+x} where x is 1, 2, or 3 and y is 1 or 2, MF, M₂SiF₆, MIO₃, M₂MoO₄, where M is Li, Na, K, Rb, or Cs, or a combination thereof. Examples of alkali metal salt activators that can be used include carbonate, silicate, or a combination thereof. Hardened polysialates and cements can also be used as activators in the methods herein.

Where a settable spacer fluid is used, it is typically desired that the spacer fluid remain pumpable until the spacer fluid reaches a target location. Because the spacer fluid is used to facilitate subsequent well construction or completion operations, after displacing drilling fluid using the spacer fluid, other fluids may be pumped into the well to displace the spacer fluid to its final target location. Because such operations can take time, it is often useful to delay the slurry phase transformation of the spacer fluid into a solid material. Delay in such cases can be accomplished by using an activator system with controlled activity. The activator systems herein release enough hydroxyl ions into the aqueous medium to activate the polymerization, but does so slowly.

The activator system with controlled activity can use any of the activators described above in a way that provides controlled activity of the activator. In one case, the activator can be coupled with a delayed release structure to give an activator system with controlled activity. For example, a liquid activator, such as sodium hydroxide or potassium hydroxide solution, or mixture thereof, can be impregnated into a solid porous medium. The solid porous medium can have porosity selected to absorb a desired quantity of the activator solution and to release the activator solution at a desired rate into an aqueous medium, potentially at a specific condition, such as a temperature or pressure, that might be encountered in the subterranean environment. Use of a porous medium to release the activator solution into the spacer fluid can delay onset of polymerization until the spacer fluid has reached its target subterranean location. The porous medium can be any base-tolerant porous solid designed to allow controlled release of liquids, such as fume silica, silica sol gels, porous clays, porous volcanic materials such as pumice, porous ceramics, porous base-resistant polymers such as polyolefins and polyether ether ketone (“PEEK”), and other porous powdered or ground materials. Particles of the porous medium, for example in the form of a powder, can be added to the activator solution to absorb the activator solution. The absorption can be by incipient wetness impregnation, wet impregnation, vacuum impregnation, or other suitable pore filling mechanism.

In another embodiment, a solid activator, for example any of the dry activators above, can be encapsulated with a coating that degrades slowly to release the activator into the spacer fluid. For example, a powder of the dry activator can be added to a solution of polyvinyl alcohol (“PVA”), or the solution can be sprayed or otherwise applied to the particles, and the resulting wet particles dried, to produce activator particles coated with PVA, which will slowly dissolve in water. The time to dissolve the coating can be selected by varying the coating thickness. The coating thickness can be varied by varying the amount of PVA dried onto the particles. Other water soluble polymeric materials, such as polysaccharides, polyethylene glycols, polyvinylpyrrolidones, cellulose ethers, and polyacrylamides can also be used, alone or in combination, to coat activator particles in a water-soluble coating.

Other ways of delaying polymerization of a polymerizable spacer fluid include using delay additives that act to reduce reaction rate of the polysialation reaction. Retardant reagents such as sodium pentaborate decahydrate, borax, sucrose, boric acid, lignosulphonates, sodium glucoheptonate, tartaric acid, citric acid, or phosphorus containing compounds such as phosphoric acid, salts thereof, or mixtures thereof can be added to the spacer fluid in amounts that depend on the quantity of polymerizable raw materials and the pH to be achieved by the activator. Where the quantity of polymerizable raw materials to be used in the spacer fluid is low, polymerization rate at a given pH will be correspondingly low. In such cases, further delayed polymerization can be achieved using a retardant additive. Polymerization rate is a continuous function of raw material concentration, pH, and temperature that can be moderated and/or influenced by amount of retardant added to the spacer fluid. Retardants that can be used include sodium pentaborate decahydrate, borax, sucrose, boric acid, lignosulphonates, sodium glucoheptonate, calcium glucoheptonate, tartaric acid, citric acid, phosphorus containing compounds such as phosphoric acid, salts thereof, and mixtures thereof.

Other ways of delaying polymerization of a polymerizable spacer fluid include using a low concentration of polymerizable raw materials in the spacer fluid. A standard polysialate precursor for forming a sheath along a well wall might have 60% or more by weight of a polysialate raw material, such as a fly ash, with an additional 20% by weight of an activator and another 20% by weight of various additives for a polymerization precursor having slurry density of about 14.5 pounds per gallon (ppg). For a lower density precursor, such as 11.5 ppg, the standard mixture might have 30% by weight of a polysialate raw materials. Reducing the amount of polysialate raw material in a polymerization system for a spacer fluid, for example by 10-30%, will slow the rate of reaction, and can potentially reduce the structural strength, e.g. compressive strength, of the solidified spacer fluid. In many uses, however, the compressive strength of the spacer fluid, after solidification, need not be very high. For example, in many cases a compressive strength of 50 psi is adequate for a solidified spacer fluid. Thus, a spacer fluid that contains a reduced content of polysialate raw material can be solidified after a suitable time for pumping and displacement to a target location. Thus, polymerizable spacer fluids having density near that of water, with very low polymerizable solids content, for example as low as 5% by weight, can be used. These fluids might develop a compressive strength of only 50 psi after polymerization, which may be suitable for some applications. In many cases, the spacer fluid can have a concentration of polymerizable raw materials that is from 5 wt % to 50 wt %, or less than about 30 wt %, such as from 5 wt % to 30 wt %, for example about 10 wt % based on the weight of the spacer fluid.

Other ways of delaying polymerization of a polysialate, or other alkali-activated, polymerization system in a spacer fluid include lowering pH at which the reaction is performed. A higher pH system has more activating hydroxyl ions in the aqueous reaction system. Reducing the number of such ions will reduce the reaction rate for a polymerization reaction activated by hydroxyl ions. Thus, reducing the amount of activator such that the polymerization system develops a pH below a standard pH for polymerizing a polysialate system, for example less than about 12, such as 9-11, for example about 10, can reduce the polymerization rate to allow time for the spacer fluid to be pumped into the well and displaced to a target location before solidifying. Any of the methods above can be used in combination. Thus, a solidifiable spacer fluid can contain a polymerizable raw material and an activator in an aqueous medium. The activator can be configured with a delay structure, such as porous carrier or an encapsulation, that slows release of the activator into the aqueous medium. Additionally or alternately, the activator can be present in a quantity that results in a pH selected to provide a polymerization reaction rate that delays solidification of the spacer fluid to a time sufficient to place the spacer fluid at a target location. Additionally or alternately, the polymerizable raw material can likewise be present in a quantity selected to provide a similarly slow reaction rate along with suitable compressive strength after solidification. Additionally or alternately, retardant reagents can be included in the spacer fluid.

Another way of controlling reaction rate of the polysialation reaction of a spacer fluid is to select a particle size distribution for the polymerization raw material particles. The rate of a polysialation reaction depends partly on the size of the particles of reactive raw materials in the reaction system. Larger particles react more slowly, so including larger particles in a polymerization precursor mixture can reduce the rate at which the polymerization reaction proceeds. For example, a spacer fluid that has polymerization raw materials with particle size distribution such that D50 (the particle diameter at which 50% of the mass of the particles in the mixture have diameter less than the D50 diameter) is at least 50 μm will react more slowly than a similar spacer fluid where the polymerization raw materials have D50 of 15 μm. A spacer fluid can use polymerization raw material particles having at least some larger particles to provide a moderate or slow reaction rate such that the spacer fluid can be pumped and placed at a target location before the spacer fluid becomes unpumpable. As noted elsewhere herein, a particle size distribution selected to provide a reaction time or reaction rate to support placing the spacer fluid at a target location before setting can be used with other techniques mentioned herein.

Another way of controlling reaction rate of the polysialation reaction of a spacer fluid is to use polymerization raw materials having different reaction rates. The spacer fluid can contain a first polymerization raw material having a first alkaline reactivity and a second polymerization raw material having a second alkaline reactivity different from the first alkaline reactivity. The first and second alkaline reactivity can be selected to provide a controlled rate of polymerization, thickening and/or solidification, of the spacer fluid. For example, the first or the second reactivity can be selected to provide a thickening time sufficient to allow pumping the spacer fluid, along with other fluids in the well, to place the spacer fluid at a target location before the spacer fluid becomes unpumpable. Polymerization raw materials having a high content of calcium oxide, for example, will have higher alkaline reactivity. Polymerization raw materials such as GGBS and Fly Ash Type C have calcium oxide content above about 18 wt %, whereas metakaolin and Fly Ash Type F have calcium oxide content less than 18 wt %. Such materials can be used in mixtures to target a reaction rate based on chemical composition. Such materials can also be sized to have a particle size distribution that contributes to targeting a reaction rate for the spacer fluid. Any of the other techniques described herein can also be used in combination with chemical and physical properties to give a reaction rate or reaction profile that enables use of a polymerizable spacer fluid material.

Thus, polymerization mixture having a target reaction rate can be used in a spacer fluid to solidify the spacer fluid after deployment into a well. The polymerization mixture can be designed, that is the types and amounts of ingredients can be selected, to provide a reaction rate, and rate profile (i.e. time of reaction onset, initial reaction rate, maximum rate of reaction, time to reach maximum reaction rate, rate of decline in reaction, etc), to provide a spacer fluid capable of facilitating displacement of fluids within a well and to allow time to place the spacer fluid, and other fluids, at target locations within the well before the spacer fluid becomes unpumpable. Such a polymerization mixture can use water of any suitable type, such as fresh water, salt water, sea water, ground water, or water with any desired additives. The polymerization mixture can have a reduced amount of polymerizable raw materials such as aluminosilicates, a reduced amount of activator to provide a low pH for an alkali activated polymerization reaction, slow rising pH, for example by using encapsulated or otherwise slow-released or release delayed activators, a particle size distribution selected to provide a controlled polymerization rate, and/or polymerization inhibitors. Any combination of such methods can be used to provide a polymerization precursor that has a controlled reaction for use as, or with, a spacer fluid. In some cases, an unsettable spacer fluid can also be used with a polymerizable spacer fluid according to any of the types described herein.

The polymerization mixture used in the spacer fluid can use a polymerizable raw material and a high amount of retardant in a polymerizable spacer fluid that has a slurry density less than about 14 ppg. This polymerizable spacer fluid would have an amount of alkali activator typically used with a polysialate precursor of the same density, but would have an amount of retardant that is at least about 1 wt % based on the weight of the slow polymerization mixture. The amount of retardant, in some cases, may be 5 wt % or less based on the weight of the slow polymerization mixture.

Using a controlled reaction rate polymerization mixture in a spacer fluid has the added benefit of providing a spacer fluid that develops a low compressive strength that is, nonetheless, suitable for a solidified spacer material. In general, as mentioned above, in addition to a spacer material, a cementitious precursor material is typically also provided to a well to create a strong, solid lining along the walls of the well. One benefit of using a reactive spacer material, as described herein, is to avoid excessively diluting any of the cementitious raw material that is flowed into the well in contact with the spacer material. If the spacer material contains some polysialate raw materials, any dilution of the cementitious material, at the fluid interface with the spacer material, during pumping can be managed and/or minimized. Such methods avoid reducing the strength, for example the compressive strength, of the set cementitious material that forms the lining of the well. The compressive strength of the set spacer material, itself, allows the spacer material to be left in the well, rather than completely displaced from the well, saving time and resources in well completion. Using a slow polymerization mixture allows the spacer material to remain fluid while drilling fluid is displaced from the well and while cementitious precursors are placed into the well, and reduces dilution or contamination of the cementitious precursors during movement into the well.

In operation, when well drilling is finished and the well is to be completed, a well casing (typically a pipe) is inserted into the well to form a central conduit and an annulus between the casing and the wellbore wall. A polymerizable spacer fluid is formulated as described herein, and pumped down the well using the central conduit. Pumping the spacer fluid forces the drilling fluid to flow along the annulus to the surface, displacing the drilling fluid from the well. As described above, the high pH of the spacer fluids described herein can be helpful in removing oleaginous components of the drilling fluid from the well. After a suitable quantity of spacer fluid has been introduced to the well to prevent any unwanted mixing of drilling fluid with subsequent fluids, a subsequent fluid is pumped down the central conduit of the well, displacing the spacer fluid and any remaining drilling fluid into the annulus. Typically, the amount of spacer fluid and subsequent fluid is sufficient to totally displace all drilling fluid from the well, and in many cases some spacer fluid is also displaced from the well to ensure all the drilling fluid is removed. In many cases, the subsequent fluid is a cementitious precursor, for example a conventional cement or a polysialate precursor, widely used to create a cementitious lining between the casing and the wellbore wall. In such cases, an amount of the cementitious material sufficient to fill a target portion of the annulus is pumped into the central conduit of the well. To displace the cementitious material into its final target location in the annulus, a subsequent fluid can be pumped into the central conduit. The polymerizable spacer fluid is frequently finally located in the annulus immediately above the final location of the cementitious material, so that the cementitious material is not needed within the entire annulus, or even within the entire target area, and the cementitious material and the spacer fluid are then allowed to harden within the annulus. Because the spacer fluid is often finally disposed in the well at a depth that is less than the cementitious material, the spacer fluid can provide isolation at lower compressive strength than might be needed for the cementitious material, enabling more versatility in formulating the settable spacer fluid.

The spacer fluid can include additives for various functions. Density control additives are typically added, as described above, to provide sufficient weight to displace the drilling fluids from the well. The density control materials can be solids and/or liquids and can include solid salts of heavy metals and solutions of heavy metals. Many conventional density control materials can be used. Examples of non-soluble density modifier additives include pumice, hematite, barite, ilmenite, silica, manganese tetroxide, calcium carbonate and combinations thereof. These materials typically increase the bulk density of a spacer fluid. Soluble materials can also be used as density modifiers. Such materials are typically alkali metal salts, for example salts of lithium, sodium, potassium, rubidium, and cesium, or combinations thereof. Such materials can be used to increase or decrease bulk density of a spacer fluid, depending on other components of the fluid. The anions of such salts can be organic or inorganic, or a combination thereof. The organic anions can be selected from the group consisting of formate, acetate, propionate, butyrate, isobutyrate, maleate, malonate, succinate, fumarate, and combinations thereof. The inorganic anions can be selected from the group consisting of chloride, fluoride, bromide, iodide, nitrate, nitrite, and combinations thereof. An example of a water-soluble density modifier that can be used is cesium formate.

Other additives can be included in the spacer fluid. Viscosifiers such as polysaccharide materials, for example biopolymers, can be used. Examples of polysaccharide viscosity modifiers include diutan gum, polyanionic cellulose, welan gum, xanthan gum, and carboxymethylcellulose. Mixtures of such materials can also be used. Such viscosity modifiers can be used in amounts of 0.1-2% by weight of the polymerization precursor blend. Viscosifiers are generally added to provide a viscosity sufficient to maintain colloidal dispersion of the settable spacer fluid for a time sufficient to place the spacer fluid at its target location and then solidify the spacer fluid. Materials such as gluconic acid and soluble salts thereof, glucoheptonic acid and soluble salts thereof, tartaric acid and soluble salts thereof, citric acid and soluble salts thereof, glycolic acid and soluble salts thereof, lactic acid and soluble salts thereof, formic acid and soluble salts thereof, acetic acid and soluble salts thereof, proprionic acid and soluble salts thereof, oxalic acid and soluble salts thereof, malonic acid and soluble salts thereof, succinic acid and soluble salts thereof, adipic acid and soluble salts thereof, malic acid and soluble salts thereof, nicotinic acid and soluble salts thereof, benzoic acid and soluble salts thereof, phosphoric acid and soluble salts thereof, inorganic salts, and ethylenediamine tetraacetic acid (EDTA) and soluble salts thereof may be included in settable spacer fluids as retarders or dispersants or both. Such salts can also serve as accelerants and retardants in some situations. Other additives, such as foam control agents, fluid loss control agents, fibers for enhanced fluid displacement, loss circulation materials for sealing fractures, anti-settling agents, dispersants, and combinations thereof can also be used in a settable spacer fluid. Surfactants such as ethoxylated or polyethoxylated nonylphenols, fatty acids, viscoelastic surfactants, betaine-based surfactants, and the like, can also be used to enhance wetting, and therefore adhesion of polymerizable spacer fluid within the annulus. Such wetting enhancement can also enhance displacement of drilling fluid, and components thereof, from the well.

The settable spacer fluids described herein can be used with other spacer fluids that do not solidify. For example, an unsettable spacer fluid can be pumped into a well to displace, at least partially, a drilling fluid, and then a settable spacer fluid can be pumped after the non-settable spacer fluid, and before a subsequent fluid such as a cementitious precursor. In such cases, the wellbore annulus will have a settable spacer fluid and, potentially, a cementitious precursor to harden in the annulus while the drilling fluid is removed and the unsettable spacer fluid can be removed or left in the well annulus.

It should be noted that the settable spacer fluids described herein are delivered at high pH, eliminating the possibility of metal corrosion, for example of the well casing, due to components of the settable spacer fluid. Thus, these spacer fluids can typically be deployed without using any corrosion inhibitor materials. Also, due to the ability to solidify, these spacer fluids typically do not need extra stabilization to prevent settling over longer periods of time.

While the foregoing is directed to embodiments of the present invention, other and further embodiments of the present disclosure may be devised without departing from the basic scope thereof, and the scope thereof is determined by the claims that follow.

We claim:

1. A method of treating a well, comprising:
pumping a spacer fluid into the well, the spacer fluid comprising an aqueous medium, a polymerizable raw material, and an activator system that comprises 1) an activator and a release delay structure; or 2) an activator with a retardant reagent; or 3) an activator solution that gives the spacer fluid a pH of about 12 or less;
displacing the spacer fluid to a target location within the well; and
allowing the spacer fluid to solidify at the target location.

2. The method of claim 1, wherein the activator system comprises an activator and a release delay structure that is a porous medium or an encapsulation.

3. The method of claim 1, wherein the spacer fluid has a slurry density of less than about 14 pounds per gallon.

4. The method of claim 1, wherein the spacer fluid has a pH of about 12 or less, and the polymerizable raw material is present in the spacer fluid at a concentration of about 5 wt % to about 50 wt % based on the weight of the spacer fluid.

5. The method of claim 1, wherein the activator system comprises an activator and a retardant reagent, wherein the retardant reagent is present in the spacer fluid at a concentration of at least about 1 wt % based on the weight of the polymerizable raw material.

6. The method of claim 1, wherein the spacer fluid further comprises a density control additive, a viscosity modification additive, or both.

7. The method of claim 6, wherein the spacer fluid further comprises a foam control agent, a fluid loss control agent, a fiber material for enhanced fluid displacement, a loss circulation material for sealing fractures, an anti-settling agent, a dispersant, a surfactant, or a combination thereof.

8. A method of treating a well, comprising:
pumping a drilling fluid into a well;
displacing the drilling fluid using a polymerizable spacer fluid having a density selected to displace the drilling fluid and having polymerization raw materials selected to provide a controlled polysialation reaction;
displacing the polymerizable spacer fluid to a target location within the well; and
allowing the spacer fluid to polymerize at the target location.

9. The method of claim 8, wherein the polymerizable spacer fluid comprises an alkali activator, and a retarder in a concentration of at least about 1 wt % based on the weight of the polymerization raw materials.

10. The method of claim 8, wherein the polymerizable spacer fluid comprises a plurality of alkaline reactive polymerization raw materials having alkaline reactivities selected to provide a thickening time of the spacer fluid sufficient to allow pumping the spacer fluid to a target location before the spacer fluid becomes unpumpable.

11. The method of claim 8, wherein the polymerizable spacer fluid has an activator system with controlled activity, the polymerization raw materials have a particle size distribution selected to provide a controlled polymerization rate, the polymerization raw materials comprise a first polymerization raw material having a first alkaline reactivity and a second polymerization raw material having a second alkaline reactivity different from the first alkaline reactivity, the polymerizable spacer fluid contains at least about 1 wt % of a retardant reagent based on the weight of the polymerization raw materials, the polymerizable spacer fluid has a pH less than about 12, or a combination thereof.

12. The method of claim 8, wherein the polymerizable spacer fluid has a density control additive and a concentration of polymerization raw materials less than about 30 wt % based on the weight of the polymerizable spacer fluid.

13. The method of claim 8, wherein the polymerizable spacer fluid further comprises a viscosity modification additive, a foam control agent, a fluid loss control agent, a fiber material for enhanced fluid displacement, a loss circulation material for sealing fractures, an anti-settling agent, a dispersant, a surfactant, or a combination thereof.

14. A spacer fluid for use in a well, the spacer fluid comprising:
an aqueous medium comprising a polymerization mixture disposed in the aqueous medium, the aqueous medium having a pH less than about 12, the polymerization mixture having a controlled reaction rate in the aqueous medium that solidifies the spacer fluid after a predetermined time disposed in the aqueous medium.

15. The spacer fluid of claim 14, wherein the polymerization mixture comprises an alkaline-reactive raw material, an alkali activator, and a retarder in a concentration of at least about 1 wt %, based on the weight of the polymerization mixture, and wherein the spacer fluid has a slurry density of less than about 14 pounds per gallon.

16. The spacer fluid of claim 15, wherein the alkaline-reactive raw material is present in the spacer fluid at a concentration of about 5 wt % to about 50 wt % based on the weight of the spacer fluid.

17. The spacer fluid of claim 15, wherein the alkaline-reactive raw material is present in the spacer fluid at a concentration of less than about 30 wt % based on the weight of the spacer fluid.

18. The spacer fluid of claim 14, wherein the spacer fluid has an activator system with controlled activity, the polymerization mixture comprises polymerization raw materials that have a particle size distribution selected to provide a controlled polymerization rate, the polymerization mixture comprises a first polymerization raw material having a first alkaline reactivity and a second polymerization raw material having a second alkaline reactivity different from the first alkaline reactivity, the spacer fluid contains at least about 1 wt % of a retardant reagent based on the weight of the polymerization raw materials, the polymerizable spacer fluid has a pH less than about 12, or a combination thereof.

19. The spacer fluid of claim 14, further comprising a density control additive, a viscosity modification additive, a foam control agent, a fluid loss control agent, a fiber material for enhanced fluid displacement, a loss circulation material for sealing fractures, an anti-settling agent, a dispersant, a surfactant, or a combination thereof.

20. The spacer fluid of claim 14, wherein the polymerization mixture comprises polymerization raw materials having a particle size distribution selected to provide the controlled reaction rate.
